(19) United States
(12) Patent Application Publication
(10) Pub. No.: US 2023/0035516 A1
(43) Pub. Date: Feb. 2, 2023

(54) METHOD AND SYSTEM FOR PAYMENTS VIA TEXT MESSAGES

(71) Applicant: Leon Arango, Atlanta, GA (US)

(72) Inventor: Leon Arango, Atlanta, GA (US)

(21) Appl. No.: 17/443,736

(22) Filed: Jul. 27, 2021

(51) Int. Cl. G06Q 20/32; G06Q 20/40; G06Q 20/20

(52) U.S. Cl. CPC G06Q 20/3255; G06Q 20/202; G06Q 20/4012

(57) ABSTRACT

A system and method for sending and receiving payments via messages are provided. The methods include utilizing a transaction server loaded with a chatbot. Payment can occur via a message exchange with the chatbot and a user’s mobile phone.

### BRIEF SUMMARY OF THE INVENTION

This disclosure generally relates to transferring money between two parties, such as person to person, person to business, or business to person. More specifically, this disclosure relates to transferring money through a Short Message Service (SMS) or other messaging medium.

### BACKGROUND OF THE INVENTION

Proliferation of mobile devices created many modern conveniences, ranging from entertainment to conducting businesses transactions. Specifically, smartphones, such as those running iOS or Android, significantly improved the quality of life for many people worldwide.

However, smartphones and other similar devices are not widely available in many parts of the world, either due to costs, lack of infrastructure or education, or a general distrust of modern technologies such as mobile applications (apps).

As such, in many parts of the world, mobile phones are predominantly non-smart phones (i.e., dumb phones or feature phones). These mobile devices may only be capable of making and receiving calls and sending and receiving text messages (such as SMS). These devices may have limited internet connection capabilities, if available, and may be incapable of running most, if not all, modern applications, such as those available on iOS or Android.

Further, in many parts of the world, such as countries in Central and South America, financial transactions are mainly carried out using paper currencies. In many Central and South American countries, although the majority of population have mobile devices, the denizens of these countries do not conduct financial transaction applications using mobile applications and online payment systems (such as Venmo or Zelle) because, for example, the mobile devices cannot run associated mobile applications or cannot access the internet. These mobile devices may also be incapable of accessing websites (such as PayPal), so web-based or app-based financial services are not readily available in these countries. Thus, there is a need to provide a platform for digital financial transactions that can be achieved through using any mobile device.

Moreover, the primitive financial infrastructure and restrictive innovation environment also contribute to a lack of digital financial transactions in these countries. It is not uncommon for a bank in these countries to be without a Society for Worldwide Interbank Financial Telecommunication (SWIFT) code for example.

Likewise, technical illiteracy is another significant issue facing these countries, and many Central and South Americans do not have access to a computer or online network. Thus, even if financial websites (such as PayPal) are available in these countries, a majority of the population cannot access them due to not knowing how to use these websites, or do not know how to sign up to use the services. Thus, there is a need for a platform that conducts digital financial transactions yet requires minimal technical knowhow for use.

### BRIEF DESCRIPTION OF THE DRAWINGS

FIG. 1 illustrates a flowchart for initiating a person-to-person transaction according to an exemplary embodiment.

FIG. 2 illustrates a flowchart for completing the person-to-person transaction as shown in FIG. 1.

FIG. 3 illustrates a flowchart for a person-to-business transaction according to an exemplary embodiment.

FIG. 4 illustrates a flowchart for a business-to-person transaction according to an exemplary embodiment.

FIG. 5A illustrates various safe groups that can be set up for a user according to an exemplary embodiment; FIG. 5B illustrates a simplified process of creating and managing safe groups of FIG. 5A; FIG. 5C illustrates a diagram of how the safe groups of FIG. 5A can be implemented in a business-to-person transaction according to an exemplary embodiment.

FIG. 6A illustrates a system diagram that can be used to implement methods of financial transactions according to an exemplary embodiment; FIG. 6B illustrates a system diagram of a server architecture that can be used to implement methods of financial transactions according to an exemplary embodiment..

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

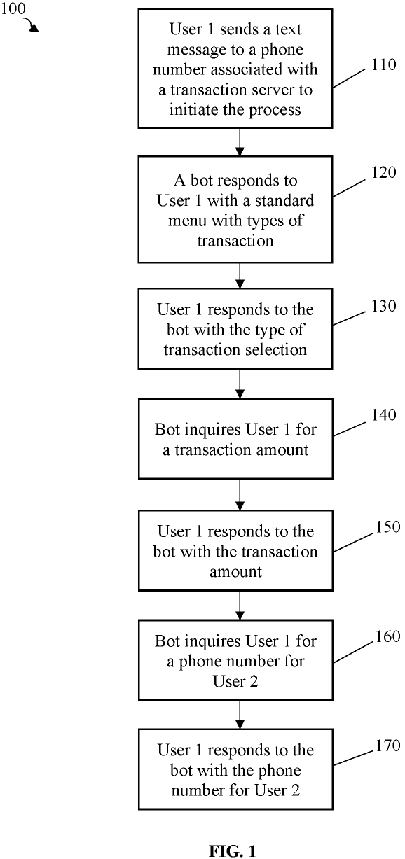

FIGS. 1-6 illustrate several methods and systems for conducting a financial transaction according to various embodiments.

Preliminarily, a user can be enrolled to use the financial transaction method and system provided herein through many suitable ways. In some embodiments, a service provider providing the financial transaction service can partner with one or more financial institutes (such as banks and credit unions). Since the financial institutions already have bank account numbers, as well as other personal information, including phone numbers, for their customers, the customers of such financial institutions may not need to take additional steps to enroll (i.e. bank customers are automatically enrolled). Alternatively, the customers can receive notifications or messages on their phones, asking the customer to accept the enrollment. In other embodiments where the service provider does not partner with financial institutions, or desires to provide additional enrollment avenues, in-person sign-up, web-based sign-up, dedicated kiosks, or other appropriate means can be used to associate a user’s phone number with said user’s banking information, thereby enrolling a customer in the financial transaction service. For example, a user can go to an in-person kiosk and enroll in the service by providing the user’s phone number and banking information, such as account number and bank routing information, to a representative of the financial transaction service working at the kiosk. Alternatively, a user can enroll using a computer terminal, at the kiosk or at home, via a web-based sign-up form. In some cases, a user merely needs to provide the user’s phone number, whereas the pairing of the user’s phone number with the user’s banking information can be done by financial institutions utilizing the financial transaction service. Certainly, security measurements can be implemented during enrollment, such as requiring identification verification of the enrollee or the like. Furthermore, in some embodiments, users can create or request a personal identification number (PIN) that can be used during transactions. The PIN can also be used for other purposes such as for security related reasons. For example, the PIN can be used to freeze an account if the user’s phone is lost or stolen, or to report a lost phone. Moreover, businesses and corporate entities can also sign-up for the financial transaction service described herein by associating one or more phone numbers with one or more corporate bank accounts. Individual users and business entities can sign up via different methods. For example, a retailer can sign-up for service by associating a bank account with the business entity (i.e., the bank account of ABC Grocery) instead of associating the bank account with a specific phone number of the retailer.

Referring to FIG. 1, process 100 illustrates a method for initiating a financial transaction from the perspective of the initiator (i.e., “User 1” in this example). Specifically, User 1, who has been previously enrolled in the financial transaction service described herein, may request payment from or send money to User 2, who has also previously enrolled in the financial transaction service described herein. In either scenario, at step 110, User 1 can send a first message to a phone number associated with a transaction server. In a preferred embodiment, all messages can comprise a Short Message Service (SMS) text message. In other embodiments, all messages can comprise a Multimedia Messaging Service (MMS) message, an instant message (IM), an email, an iMessage message, a WhatsApp message, or a phone call (if the transaction server is equipped with an auto-attendant phone system capable of understanding and deciphering human speech). The message protocol used can depend on the specific implementation of the transaction server herein as well as the desired functionalities. By way of example, in some embodiments where User 1 has access to a computer with internet connection, User 1 can initiate a transaction via IM on the computer instead of SMS through a mobile phone.

The transaction server can be a computer server or servers configured to implement various functions utilized throughout the processes herein. In general, the transaction server can at least include one or more processors coupled to memories that can be used to execute software thereon and thus perform various functionalities. Moreover, the transaction server can also include communication interfaces that enable the transaction server to communicate with external networks through the internet, telephone networks, or other suitable telecommunication channels. In an embodiment, the transaction server can be loaded with a chatbot that can be used to conversate with users, acting as an interface between the transaction server and the users. In such embodiment, the first message sent by User 1 can be received by the transaction server to thereby initiate a conversation with the chatbot, and the chatbot can begin conversating with User 1 in response to receiving the first message.

In some embodiments, the content of the first message sent by User 1 can comprise any text. For example, the content can simply be the word “hello”, “hi”, or “Hola”, or the text message can comprise the text “I want to make a transaction”. Alternatively, the content can be numerical, such as a “1” or a “2”. In some embodiments, the content of the first message can be irrelevant as the first message simply serves to initiate a conversation with the chatbot. The transaction server can receive a phone number of the user included in the first message, and the transaction server can determine the user who sent the first message from the determined phone number. The transaction server can associate a bank account with the phone number to determine a source or destination for money in the transaction.

At step 120, the chatbot can respond to the first message sent by User 1 by sending a second message that presents a menu listing types of transaction or service available to User 1. For example, the chatbot can present to User 1 a menu that states: “Enter 1 for requesting money; enter 2 for sending money.” In addition, the menu can also include service options such as “Enter 3 to add people to a safe group” or “Enter 4 to freeze an account”. In an exemplary embodiment, the chatbot can send such menu to User 1 via a text message, meaning User 1 can receive such menu in a form of a reply text message from the chatbot. Generally, the second message from the chatbot can comprise the same type of message as the first message (e.g. if the chatbot received an SMS message, the chatbot sends an SMS reply message; if the chatbot received an email message, the chatbot sends an email reply message).

At step 130, User 1 can respond to the chatbot’s second message from step 120 by sending a third message to the chatbot. In an embodiment, the third message can comprise numerical values such as simply replying “1” or “2” corresponding to the menu choices presented at step 120. In other embodiments, the third message can comprise natural language responses, such as “send money” or “request money”, and such natural language responses can be decoded by the chatbot to determine User 1's intent.

At step 140, the transaction server through the chatbot send a fourth message requesting a transaction amount from User 1. For example, the fourth message can say “How much would you like to send” or “How much would you like to receive” or “Enter amount”.

At step 150, User 1 can respond to the chatbot with the transaction amount by sending a fifth message. For example, User 1 can send a text message (fifth message) to the chatbot stating “10” or “$10” or “10.00”, indicating User 1 would like to send or receive ten dollars, depending on the type of transaction selected at step 130.

In an exemplary embodiment, the transaction amount can be default to the national currency of the user. Thus, when User 1 enters “ 10”, the transaction server can interpret “10” to mean ten pesos or ten dollars or ten euros, depending on the local currency. In other embodiments, User 1 can dictate the currency to be used for a transaction. In further embodiments, multiple currencies can be used for a transaction. In some embodiments, currency exchange can be performed by the transaction server, so a first user can request (or send) an amount in a first currency, and a second user can send (or receive) the amount in a second currency.

At step 160, the transaction server through the chatbot can request a phone number for User 2 by sending a sixth message to User 1. Each phone number can be tied to a specific user or a specific business. As such, User 1 needs not provide additional identifiers for User 2, such as a bank account number or a routing number, so long as User 1 knows User 2's phone number. In this manner, neither User 1 nor User 2 needs to share their private banking information to conduct a transaction. By having a user’s phone number, the transaction server can recognize whether the user is registered for the service or not.

At step 170, User 1 can respond to the sixth message of step 160 by sending a seventh message to the chatbot listing the phone number for User 2.

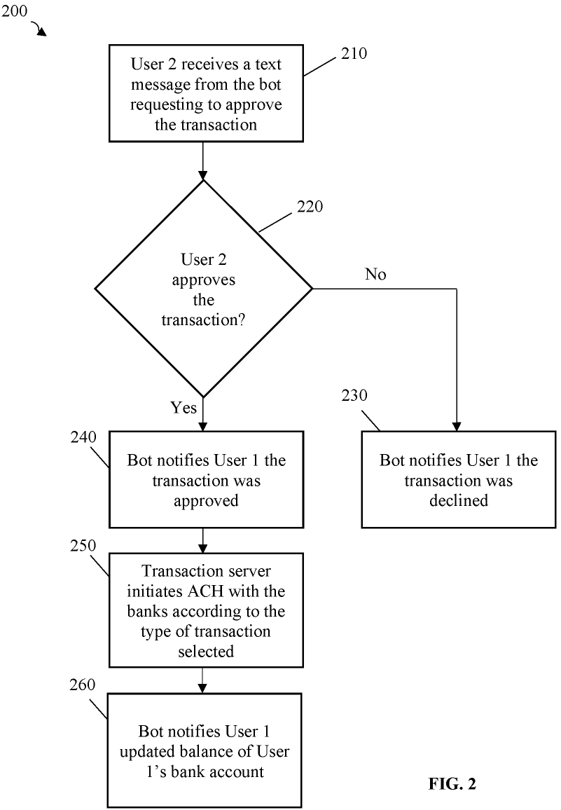

After the transaction server receives the type of transaction, the transaction amount, and User 2's phone number, turning to FIG. 2, the transaction server can initiate process 200 to conduct the transaction.

At step 210, User 2 can receive an eighth message from the chatbot prompting User 2 to approve the transaction initiated by User 1. By way of example, the eighth message can be a text message to User 2's mobile phone stating: “User 1 is requesting $10.00 from you, enter 1 to approve, enter 2 to decline” or “User 1 is sending $10.00 to you, enter 1 to approve, enter 2 to decline”.

At step 220, User 2 can respond to the chatbot to either approve or decline the transaction by sending a ninth message. In an embodiment, the ninth message can comprise numerical values such as simply replying “1” or “2” corresponding to the menu choices presented at step 210. In other embodiments, the ninth message can comprise natural language responses, such as “Approve” or “decline”, and such natural language responses can be decoded by the chatbot to determine User 2's intent.

If User 2 declined the transaction at step 220, at step 230, the chatbot can notify User 1 that the transaction was declined by User 2 by sending a tenth message to User 1, thus ending the entire transaction process.

Alternatively, if User 2 approved the transaction at step 220, at step 240, the chatbot can notify User 1 that User 2 approved the transaction by sending an eleventh message to User 1. Thereafter, at step 250, the transaction server can initiate an automated clearing house (ACH) payment between a bank account of User 1 and a bank account of User 2. While an ACH transaction has been given as an exemplary embodiment, other banking transactions are envisioned such as an e-Check, a wire transaction, or the like.

At step 260, the transaction server can send a twelfth message to User 1, notifying User 1 of the updated balance of User 1's bank account.

In some embodiments, no additional approval is needed. For example, if the transaction amount is small, the transaction server can initiate the ACH transaction without further notifications to the users (e.g. the chatbot does not send the eighth through eleventh messages). Similarly, a user may be approved or pre-approved for a periodic transaction limit (such as daily, weekly, or monthly), and so long as the transaction amount is below such transaction limit (e.g. $100, $1000, etc.), no additional approval is required. In other embodiments, additional approvals or notifications can be utilized. By way of example, the transaction server can send additional messages to the users notifying that the ACH transaction has been completed, there are insufficient funds to be transferred, delay in the ACH transaction, or other events or conditions that may warrant notifying the users.

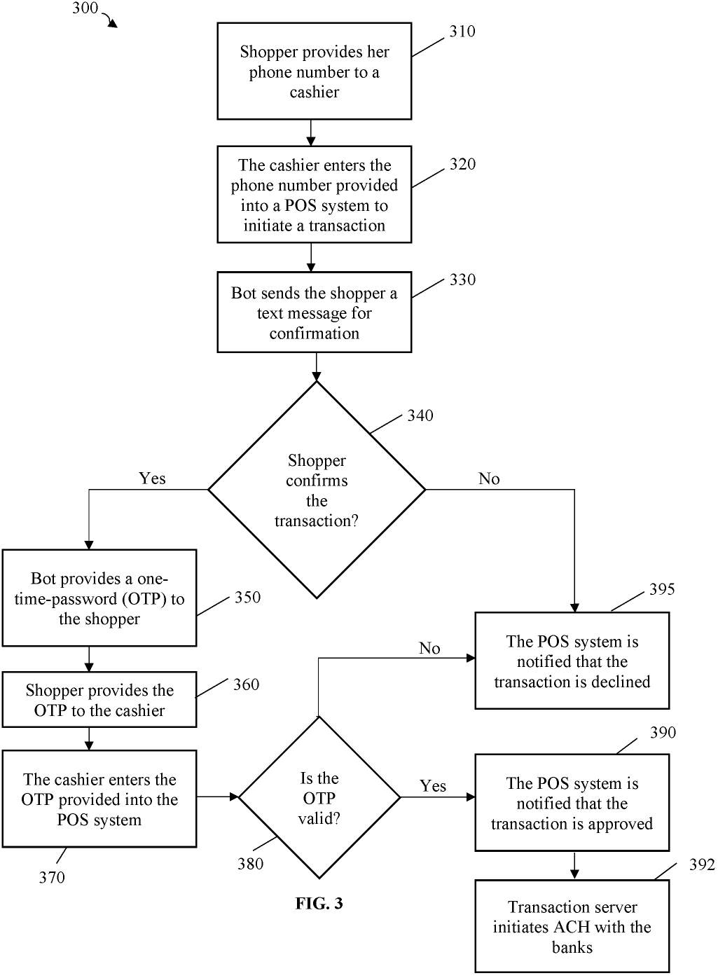

The transaction server can also be used in other circumstances, such as business-to-person (B2P) or person-to-business (P2B). Referring to FIG. 3, an exemplary person-to-business payment process 300 is illustrated. In this embodiment, both the business and the person (shopper) would already be enrolled in utilizing the transaction service.

Utilizing the transaction service, a shopper can decide to pay using her phone instead of using paper currency, credit/debit card, or fintech apps. To initiate the process, the shopper can provide her phone number to a cashier during checkout at step 310.

At step 320, the cashier can enter the shopper’s phone number into the store’s pointof-sale (POS) system that is connected with the transaction server to initiate a transaction.

At step 330, the chatbot of the transaction server can receive the shopper’s phone number from the POS, identify the shopper, and send a first message to the shopper for confirmation. For example, the first message to the shopper can state: “Grocery store A is requesting $20.00 from you, enter 1 to approve, enter 2 to decline”.

At step 340, the shopper can respond to the chatbot by sending a second text message stating the numerical option that corresponds to the options presented in step 340. For example, the shopper can respond “1” to approve or “2” to decline. Likewise, in some embodiments, natural language responses can also be used.

If the shopper approves the transaction at step 340, at step 350, the chatbot can provide a one-time-password (OTP) to the shopper. The OTP can be a string of numbers or alphanumerical values depending on the embodiments. Barcodes or Quick Response (QR) codes can also be used as the OTP in some embodiments where messaging in not limited to the SMS format. In other embodiments, the transaction server can initiate an application installed on the shopper’s phone to conduct the transaction via contactless payment or credit card. Alternatively, the transaction server can cause the shopper’s phone to initiate its contactless payment ability if the phone is equipped with such capability.

At step 360, the shopper can provide the OTP to the cashier. Here, the shopper can read the OTP to the cashier, or the shopper can simply show the OTP to the cashier (i.e., show the cashier the text message, barcode, QR code or the like from the chatbot).

At step 370, the cashier can enter the OTP into the POS system. If the OTP is numerical or alphanumerical, the cashier can enter the OTP into the POS system via a keyboard. If the OTP is a barcode or QR code, the cashier can scan the OTP into the POS system via suitable scanner devices connected to the POS system. For added security, the cashier can also request the shopper to provide her ID for verification before the cashier can enter the OPT. By way of example, the cashier can be requested to enter the shopper’s date of birth for verification purposes in addition to the OPT.

At step 380, the POS system can verify the OTP with the transaction server. If the OTP is valid, the POS system can be notified that the transaction is approved at step 390. Thereafter, at step 392, the transaction server can initiate an automated clearing house (ACH) payment between a bank account of the shopper and a bank account of the store. While an ACH transaction has been given as an exemplary embodiment, other banking transactions are envisioned such as an e-Check, a wire transaction, or the like.

If the OTP is invalid, or if the shopper declined the transaction at step 340, then the POS system can be notified that the transaction is declined at step 395. After the transaction is approved, the transaction server can initiate an ACH transaction, or other money transfer mechanism, to move money from the user’s account to a bank account associated with the business.

Similar to the P2P implementation, in certain embodiments, no additional approval is needed. For example, if the transaction amount is small, the transaction server can initiate the ACH without further notifications to the shopper or the cashier via the POS system. Similarly, a shopper may be approved or pre-approved for a periodic transaction limit (such as daily, weekly, or monthly) of a dollar amount, and so long as the transaction amount is below such transaction limit (e.g. $100, $1000, etc.), no additional approval is required. In other embodiments, additional approvals or notifications can be utilized. By way of example, the transaction server can send additional messages to the shopper notifying that the ACH has been completed, there are insufficient funds to be transferred, delay in the ACH payment, or other events or conditions that may warrant notifying the users. Likewise, the transaction server can also notify the POS system that there are insufficient funds for the transaction or other events or conditions that may warrant notifying the cashier.

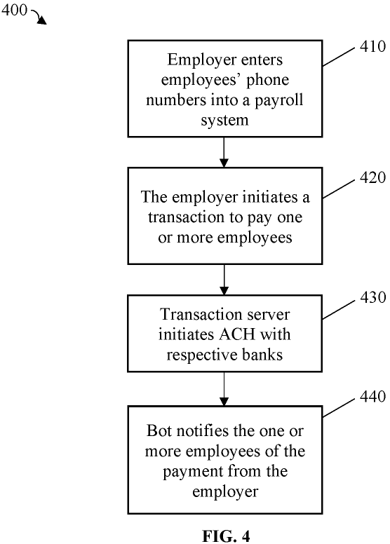

Referring to FIG. 4, an exemplary embodiment for a B2P implementation is provided in process 400.

Similar to the P2P or the P2B implementation, individual employees would already be enrolled in the transaction service. At step 410, an employer can enter employees' phone number into a payroll system. The payroll system can be connected with the transaction server previously discussed.

At step 420, the employer can initiate a transaction to pay one or more of its employees for labor. In some embodiments, the payroll system can be set up to pay the employees' salaries. In this scenario, the payroll system can be programmed to know how often and how much to pay individual employees and can initiate transactions with the transaction server accordingly. Also, the payroll system can initiate these transaction automatically on certain dates, such as a periodic payday for employees. Moreover, the employer can program the payroll system to pay a one-time bonus to a specific employee and can manually or automatically set up such payment through the payroll system. In some embodiments, the chatbot interface can be utilized by the employer instead of a dedicated or an integrated payroll system, where the employer can pay the employees using the chatbot as well as to create employee groups.

At step 430, the transaction server can initiate ACH payments from the bank account of the employer (such as a corporate bank account) to the bank accounts of the employees. As noted above, the employer needs not ask for individual employees' bank account information, as such information can already be associated with employees' phone numbers during enrollment.

At step 440, the chatbot can notify the employees that they have been paid by the employer by sending a message. For example, the chatbot can send a text message to an employees' phone number, stating “Company X paid you $200.00 on Jun. 1, 2021” or the like. In some embodiments, the chatbot can present the employees with additional menu options such as “Enter 1 to check balance; Enter 2 for account history”. The chatbot can also present the employees with a customer support number that the employees can dial for supports.

In some embodiments, the B2P implementation of process 400 can also be modified for payments between an employer and a sole proprietor. For example, the employee can be an individual that provides housekeeping service to an owner of a house. In this case, the owner can be the “employer”, and the housekeeper can be the “employee”. Under these embodiments, the payroll system can be omitted, with the transaction taking place more similar to a P2P transaction, with the caveat that in such a relationship, the transaction server can still configure it as a B2P payment, the implication of which will be described in more details below.

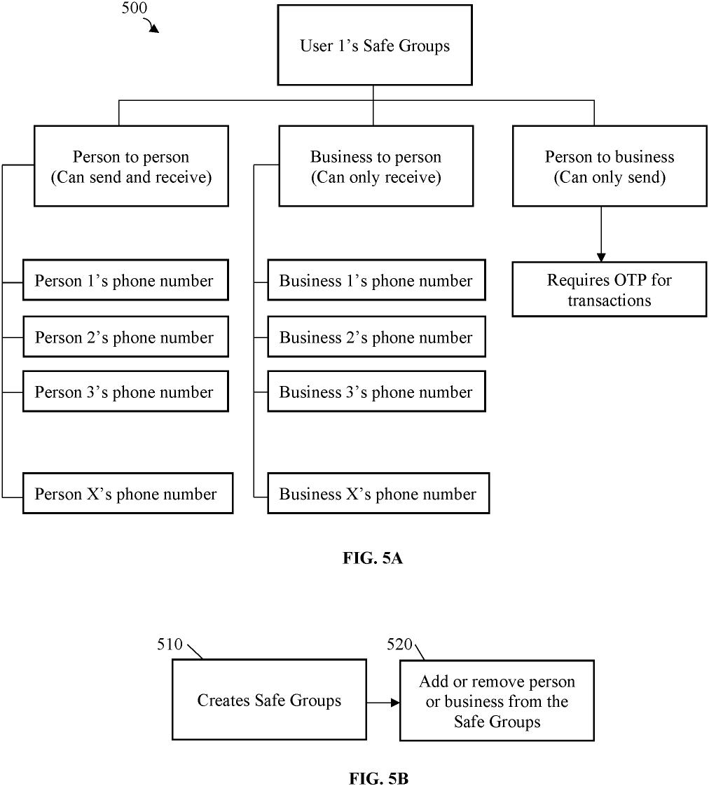

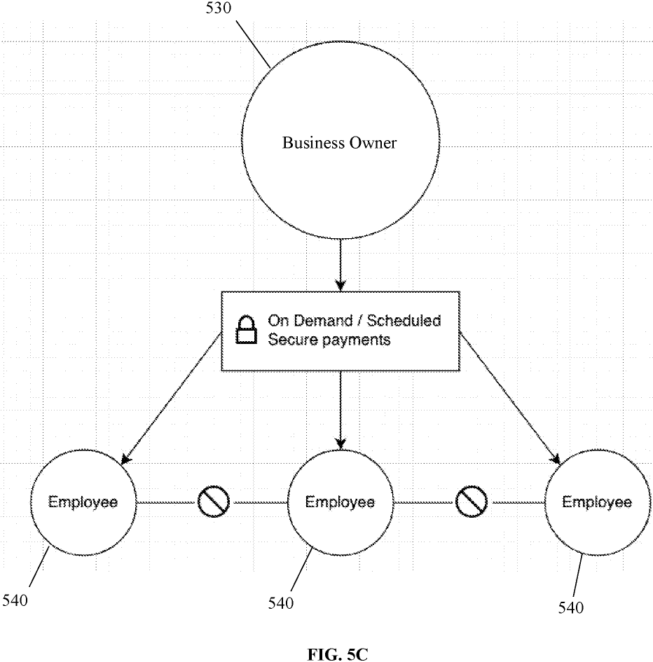

As an added layer of security to prevent fraud, money laundering, or scam, a user’s account can further define various “safe groups” 500 as shown in FIG. 5A. As previously explained, a transaction generally falls within one of three categories: P2P, B2P, or P2B. As such, a user’s account can be set up so that the user has a safe group within each category of transaction, where a different safe group has different transaction privileges, such as send only, receive only, or send and receive. In an exemplary embodiment, the safe group for P2P transactions can be limited to a predetermined number of individuals. For example, the service provider can determine that a user only gets ten (10) person within one’s P2P safe group. In this example, the user can be allowed to add up to ten (10) person’s phone number to her P2P safe group. These individuals can be close friends or family of the user or have otherwise been verified to be a part of the P2P safe group. Further, the service provider can configure the transaction server so that the user can both send and receive money to and from anyone in the user’s P2P safe group.

Similarly, the user can also have a safe group for B2P transactions, where the service provider can set these transactions to receive only from the perspective of the user. Here, the user can add the phone number of individual employers to her B2P safe group. For example, the user may regularly receive salary from Business 1. In addition, the user may also work as a housecleaner for Employer 2 and Employer 3 during her spare time. Under this example, the user can add the phone numbers of Business 1 as well as Employer 2 and Employer 3 to her B2P safe group, thereby allowing the user to receive payments from these entities without the ability to send payments in reverse. In embodiments where an employer uses a sophisticated payroll system, such payroll system can be associated with a business phone number, or that the B2P safe group can be modified to associate with a specific employer instead of a phone number of said employer.

In cases of small business (SMB) such as family owned businesses, unlike independent contractors, small businesses may be equipped with their own POS systems. In which case, the SMB can be treated as a “business” instead of a “person” (i.e., a B2B transaction), and safe groups may not be needed to conduct financial transactions between a business entity and a SMB. Alternatively, safe groups can also be used when conducting financial transactions with a SMB. Although it is contemplated that a B2B transaction generally would not need a safe group due to the increased sophistication of businesses as compared to individuals, it is to be appreciated that safe groups can also be implemented for B2B transactions and is within the scope of this disclosure.

For P2B transaction, a safe group can be omitted to provide ease of use for the user. Instead, as explained in process 300, an OTP or a PIN can be used in lieu of using a safe group to ensure security. Therefore, the user does not need to add every grocery store or gas station that she intends to shop at to a P2B safe group. Nonetheless, in some embodiments, a P2B safe group can also be utilized, where the user can only send but cannot receive money from members of the P2B safe group.

In certain embodiments, the size of individual safe groups can be modified, or can be unlimited, depending on the service provider. For example, a service provider can charge a fee to add an additional number onto a safe group, without limiting the size of the specific safe group.

In some embodiments, inclusion within a safe group will cause the transaction server to initiate an ACH transaction without additional approvals. In other words, transactions within the safe group will cause an instant transfer of money, without any investigation into fraud, validity, etc. Thus, money can move within a safe group quickly and easily.

FIG. 5B illustrates a simplified process of creating and managing a safe group. At step 510, one or more safe groups can be created. This can take place during enrollment of a user, or the user can create the safe groups with the service provider at some point after enrollment. In some embodiments, the user can have only some of the safe groups (such as P2P and B2P but not P2B or P2P only). For example, if the user only wishes to conduct P2P transactions, the user may decide not to have a B2P safe group. In other embodiments, the safe groups can be set up by default be the service provider and the user can add to said safe groups after enrollment.

At step 520, the user can add or remove a person or a business from the user’s safe group. In some embodiments, the user can visit an in-person kiosk to manage the user’s safe groups. In other embodiments, the user’s safe groups can be managed through a website, an app, or via a conversation with the chatbot. For added security, the user’s PIN can be required in order to manage or modify the user’s safe groups.

FIG. 5C illustrates a diagram of how a safe group can be implemented in a B2P transaction according to an exemplary embodiment. Here, a business owner 530 can have one or more employees 540 working for the business. In this sense, the business owner 530 can be literally, such as an individual, such as the actual owner of the business, or figuratively, such as the head of human resource, or the company itself. The business owner 530 can be added to each employee 540's B2P safe group as described in FIG. 5A, thereby enabling each employee 540 to receive money from the business owner 530. However, each employee 540 adding the same business owner 530 to their respective safe groups would not enable the employees 540 to conduct financial transactions with one another. That is to say, in this exemplary embodiment, the employees 540 can each receive money (such as salary) from the business owner 530, but the employees 540 cannot send or receive money to each other. In a further embodiment, the employees 540 can be enabled to send and/or receive money from one another by the virtue of all adding the same business owner 530 to their respective safe groups.

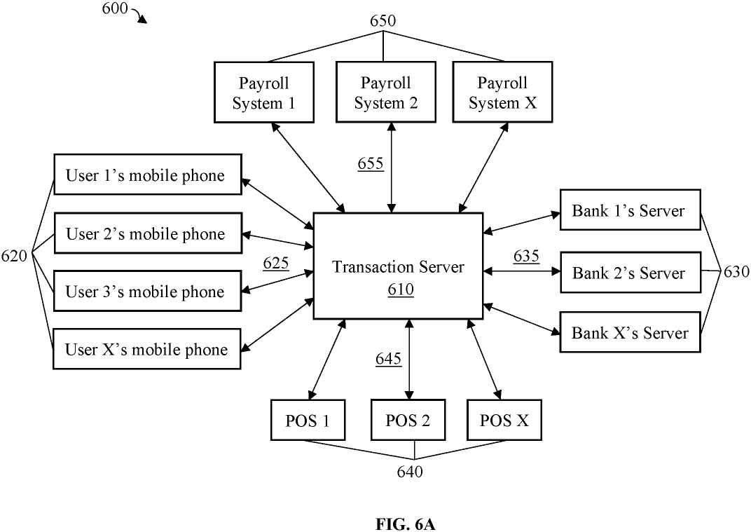

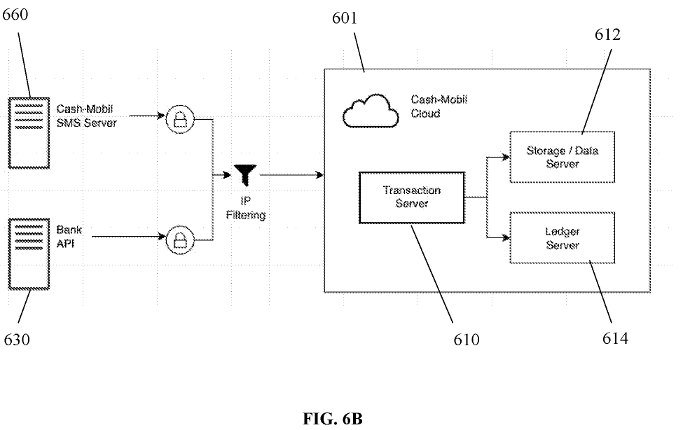

FIG. 6A illustrates an overall system diagram of utilizing the method of financial transactions disclosed herein. At the center of the overall system 600 is one or more transaction servers 610 configured to provide the functionalities discussed herein. The specific methods and processes can be written in software that can be executed by the transaction server 610.

As shown in FIG. 6A, the system 600 can include one or more users with mobile phones 620. These mobile phones can each be tied to a specific phone number of a respective user. Connections 625 between the mobile phones 620 and the transaction server 610 can be through telephonic networks. Given that some of the mobile phones 620 can be dumb phones, telephonic networks can be utilized where the text message between the transaction server 610 and mobile phones 620 are through SMS. In other embodiments, one or more connections 625 can be through the internet or a combination of internet and telephonic networks. Likewise, other suitable telecommunication channels can also be used depending on the embodiments.

The system 600 can also include one or more bank servers 630. In some embodiments, the bank servers 630 can be used to provide the back end of the financial transactions. In these embodiments, the transaction server 610 informs the bank servers 630 to transfer money from account A to account B and how much money to transfer, and the bank servers 630 can perform the underlying ACH transactions or other money transfers. Likewise, the transaction server 610 can also inquire the bank servers 630 whether sufficient funds are available for any given transaction and perform other functionalities as necessary. The connections 635 between the bank servers 630 and the transaction server 610 can be through the internet or other suitable communication channels. Alternatively, the transaction server 610 can be integrated with a bank’s internal server infrastructure, meaning a bank would not need to rely on a third-party service provider to provide the financial transactions previously described.

The system 600 can also include one or more POS systems 640 and one or more payroll systems 650. These additional systems can be used to implement P2B and B2P payments. The connections 645 between the POS systems 640 and the transaction server 610, as well as the connections 655 between the payroll systems 650 and the transaction server 610, can be the internet or other suitable communication channels.

FIG. 6B illustrates a more detailed server architecture according to an exemplary embodiment. In this embodiment, the transaction server 610 can be a part of a cloud 601. The transaction server 610 can further be coupled with or in communication with additional servers such as storge/data server 612 and ledger server 614. Put differently, various functions performed during a financial transaction can be distributed among a plurality of different components or servers instead of all being performed by one server. In an example, the data server 612 can comprise one or more databases storing information pertinent to execute the financial transaction such as users' phone numbers. Further, the ledger server 614 can comprise of one or more ledgers to record the financial transactions. In further embodiments, blockchain ledgers can be implemented instead of or in addition to the ledger server 614.

Further, a bank’s server 630 can be connected with the cloud 601 through communication channels. Similarly, a messaging server 660 can also be connected with the cloud 601 through communication channels. These communication channels can be secured and encrypted. For added security, IP filtering or other security measurements can also be implemented within the overall communication scheme. In some embodiments, the software for the chatbot can be housed at the messaging server 660 instead of the transaction server 610.

Specific embodiments of method and system for financial transactions according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A method for sending or requesting money comprising:
receiving, by a transaction server, a first message from a first user to initiate a transaction;
determining, by the transaction server, an identity of the first user based on information included in the first message;
sending, by the transaction server, a second message to the first user requesting a transaction amount for the transaction;
receiving, by the transaction server, a third message from the first user including the transaction amount;
sending, by the transaction server, a fourth message to the first user requesting identification information of a second user involved in the transaction;
receiving, by the transaction server, a fifth message from the first user including the identification information of the second user;
determining, by the transaction server, an identity of the first user based on identification information included in the fifth message; and
initiating, by the transaction server, a money transfer command with a bank server to transfer money between a bank account associated with the first user and a bank account associated with the second user.

2. The method of claim 1, wherein the first, second, third, fourth, and fifth messages comprise Short Message Service (SMS) protocol.

3. The method of claim 1, wherein the third and fifth messages comprise only numerical values.

4. The method of claim 1, further comprising:
sending, by the transaction server, a sixth text message including a menu with options for types of transaction available to the first user; and
receiving, by the transaction server, a seventh text message indicating a selection of one of the options.

5. The method of claim 4, wherein the menu with options includes at least a first option for receiving a payment and a second option for sending a payment.

6. The method of claim 1 further comprising providing a chatbot at the transaction server to interact with the first and second user.

7. The method of claim 1 wherein the information included in the first message comprises the first user’s phone number, and the identification information of the second user comprises the second user’s phone number; and further comprising associating the first users' phone number with bank information of the first user and the second user’s phone number with bank information of the second user.

8. The method of claim 1 further comprising associating personal identification numbers (PIN) with the one or more users, respectively.

9. The method of claim 1 further comprising establishing a safe group for the first user for person-to-person transactions, wherein the safe group includes one or more phone numbers of users whom the first user can send and request payments to and from.

10. A method for payment in a store comprising:
receiving, by a transaction server, identification information of a shopper from a point-of-sale (POS) system associated with a business to initiate a transaction;
sending, by a transaction server, a first message to the shopper requesting approval of the transaction, wherein the first message is sent to the shopper based on the identification information;
receiving, by the transaction server, a second message from the shopper indicating whether the shopper confirms the transaction;
in response to the second text message indicating the shopper confirmed the transaction:
sending, by the transaction server, a third text message including a one-time-password (OTP) to the shopper;
receiving, by the transaction server, an input made at the POS system;
determining, by the transaction server, whether the input matches the OTP; and
in response to the input matching the OTP, initiating, by the transaction server, a money transfer command with a bank server to transfer money from a bank account associated with the shopper to a bank account associated with the business.

11. The method of claim 10, wherein the first, second, and third message comprise Short Message Service (SMS) protocol.

12. The method of claim 10, wherein the second message includes only numerical values.

13. The method of claim 10 further comprising providing a chatbot at the transaction server to interact with the shopper.

14. The method of claim 10 further comprising associating a shoppers' phone number with bank information of the shopper.

15. The method of claim 9 further comprising associating personal identification numbers (PIN) with the shopper.

16. The method of claim 15 further comprising determining, by the transaction server, whether the input matches the PIN of the shopper or the OTP;
in response to the input matching the PIN of the shopper or the OTP, notifying, by the transaction server to the POS system, that the transaction was approved; and
in response to the input not matching the PIN of the shopper or the OTP, notifying, by the transaction server to the POS system, that the transaction was declined.

17. A method for transferring money as part of a transaction comprising:
a transaction server exchanging a plurality of text messages with a first user to determine an identity of the first user, a transaction amount, and an identity of a second party of the transaction;
associating a first bank account with first user and a second bank account with a second user; and
transferring the transaction amount between the first bank account and the second bank account in response to receiving a command from the first user to conduct the transaction.
